(19) United States
(12) Patent Application Publication
(10) Pub. No.: US 2023/0237567 A1
(43) Pub. Date: Jul. 27, 2023

(54) METHOD AND SYSTEM FOR MANAGING FINANCIAL WELLBEING OF CUSTOMERS

(71) Applicant: Mindtree Limited, Bangalore (IN)

(72) Inventors: ABHIK KAR, Pune (IN); SAUHARDRA SHRIVASTAVA, Pune (IN)

(21) Appl. No.: 17/699,189

(22) Filed: Mar. 21, 2022

(30) Foreign Application Priority Data
Jan. 27, 2022 (IN) 202241004599

(51) Int. Cl. G06Q 40/02; G06Q 30/02; G06Q 30/00; G06N 20/00; H04L 51/02; G06K 9/62

(52) U.S. Cl. CPC G06Q 40/02; G06Q 30/0282; G06Q 30/0201; G06Q 30/016; G06N 20/00; H04L 51/02; G06K 9/6215

(57) ABSTRACT

A method and system for managing financial wellbeing of customers is disclosed. In some embodiments, the method includes receiving a set of data instances associated with a plurality of customers from a plurality of data sources. The method further includes segmenting the plurality of customers based on an analysis of the set of data instances associated with each of the plurality of customers. The method further includes identifying at least one customer from the plurality of customers. The method further includes analyzing the at least one data instance associated with the at least one customer to identify one or more anomalies in financial pattern of the at least one customer; determining a root cause for the one or more anomalies identified in the financial pattern of the at least one customer; and providing at least one recommendation to the at least one customer based on the determined root cause.

### TECHNICAL FIELD

Generally, the invention relates to customer finance. More specifically, the invention relates to method and system for managing financial wellbeing of customers.

### BACKGROUND

During pandemics and similar such situations, many industries get negatived impacted. Banking is one amongst those that has been particularly hard hit by the outbreak. Moreover, due to pandemic, many people are experiencing financial crises including job loss, investment losses, and income disruption. In addition to this, many people who have lost their jobs are going through humongous medical expenses due to Covid-19. Further, due to Covid-19, more than a quarter percentage of people have stopped visiting banks and have switched to branchless banking, which has otherwise been widely used by millennials. Hence, competition has rapidly increased multi-fold due to emerging digital payments platforms, neo banks, and digital or branchless banking.

Therefore, there is a need to find an innovative way for maintaining sustainable relations with people who completely rely on digital banking. Moreover, by maintaining sustainable relationship, the banks may proactively help their customers to recover from financial crises by providing guidance to their customers in taking right action towards increasing savings, reduction in expenses, and lowering debt burden. While banks and financial institutes are monitoring financial wellbeing of their customers using some existing traditional and manual approaches, none of the existing approaches may be reliable as these approaches may be promotional centric rather than context based. Further, the existing approaches may have limited and unstructured information on customer financial status. Additionally, the existing approaches may be human driven and provide customer engagement through telephony or face-to-face.

Due to above listed reasons, the banks and the financial institutes may not be able to efficiently monitor financial well-being of each customer, as the banks and the financial institutes may not be able to identify individual customers and small businesses that may be facing financial crunch. In addition, the banks and the financial institutes may fail to provide proactive help individually to each customer by establishing personalized interaction in order to engage customers. This may result in higher dissatisfaction, customer churn, and declining customer satisfaction. Further, the banks and the financial institutes may struggle to promote new revenue streams, and cross-sell or up-sell.

Therefore, there is a need of an efficient and reliable method and system for managing financial wellbeing of customers.

### SUMMARY OF INVENTION

In one embodiment, a method for managing financial wellbeing of customers is disclosed. The method may include receiving a set of data instances associated with a plurality of customers from a plurality of data sources. The method may include segmenting the plurality of customers based on an analysis of the set of data instances associated with each of the plurality of customers. The method may include identifying at least one customer from the plurality of customers. It should be noted that, a value of at least one data instance from the set of data instances associated with the at least one customer is below an associated predefined threshold. The method may include analyzing the at least one data instance associated with the at least one customer to identify one or more anomalies in financial pattern of the at least one customer. The method may include determining a root cause for the one or more anomalies identified in the financial pattern of the at least one customer, based on analysis of each of the set of data instances. The method may include providing at least one recommendation to the at least one customer based on the determined root cause.

In another embodiment, a system for managing financial wellbeing of customers is disclosed. The system includes a processor and a memory communicatively coupled to the processor. The memory may store processor-executable instructions, which, on execution, may causes the processor to receive a set of data instances associated with a plurality of customers from a plurality of data sources. The processor-executable instructions, on execution, may further cause the processor to segment the plurality of customers based on an analysis of the set of data instances associated with each of the plurality of customers. The processor-executable instructions, on execution, may further cause the processor to identify at least one customer from the plurality of customers. It should be noted that, a value of at least one data instance from the set of data instances associated with the at least one customer is below an associated predefined threshold. The processor-executable instructions, on execution, may further cause the processor to analyze the at least one data instance associated with the at least one customer to identify one or more anomalies in financial pattern of the at least one customer. The processor-executable instructions, on execution, may further cause the processor to determine a root cause for the one or more anomalies identified in the financial pattern of the at least one customer, based on analysis of each of the set of data instances. The processor-executable instructions, on execution, may further cause the processor to provide at least one recommendation to the at least one customer based on the determined root cause.

In yet another embodiment, a non-transitory computer-readable medium storing computer-executable instruction for managing financial wellbeing of customers is disclosed. The stored instructions, when executed by a processor, may cause the processor to perform operations including receiving a set of data instances associated with a plurality of customers from a plurality of data sources. The operations may further include segmenting the plurality of customers based on an analysis of the set of data instances associated with each of the plurality of customers. The operations may further include identifying at least one customer from the plurality of customers. It should be noted that, a value of at least one data instance from the set of data instances associated with the at least one customer is below an associated predefined threshold. The operations may further include analyzing the at least one data instance associated with the at least one customer to identify one or more anomalies in financial pattern of the at least one customer. The operations may further include determining a root cause for the one or more anomalies identified in the financial pattern of the at least one customer, based on analysis of each of the set of data instances. The operations may further include providing at least one recommendation to the at least one customer based on the determined root cause.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a system for managing financial wellbeing of customers, in accordance with an embodiment.

FIG. 2 illustrates a flowchart of a method for managing financial wellbeing of customers, in accordance with an embodiment.

FIG. 3 illustrates a flowchart of a method for segmenting a plurality of customers, in accordance with an embodiment.

FIG. 4 represents a logical architecture framework for configuring a system to manage financial wellbeing of customers, in accordance with an embodiment.

FIG. 5 represents a functional architecture framework for managing financial wellbeing of customers, in accordance with an embodiment.

FIG. 6 illustrates a detailed flowchart of a method for managing financial wellbeing of customers, in accordance with an embodiment.

FIG. 7 illustrates a flowchart of a method for determining net promoters score, in accordance with an embodiment.

FIG. 8 illustrates an exemplary process for managing financial wellbeing of customers, in accordance with some exemplary embodiment.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

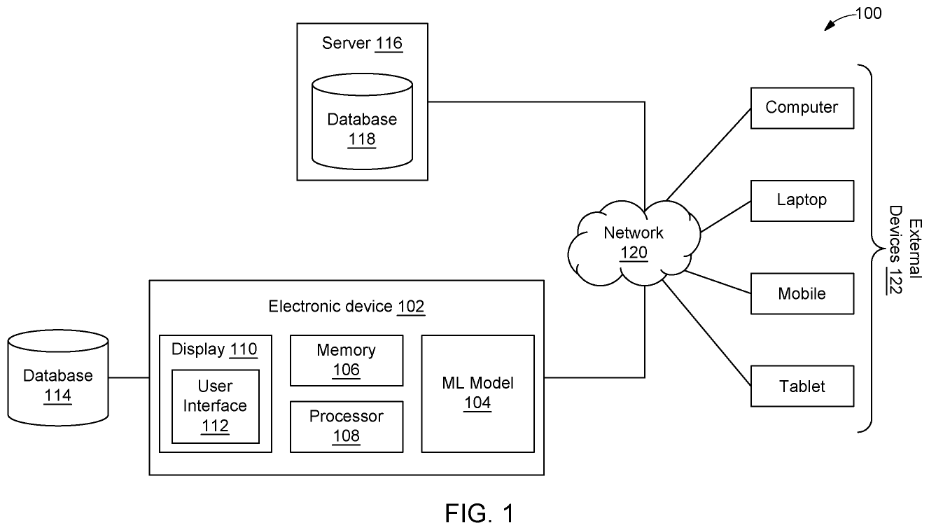

A system 100 for managing financial wellbeing of customers, is illustrated in FIG. 1. In particular, the system 100 may include an electronic device 102 that may be responsible for managing financial wellbeing of each of a plurality of customers. In an embodiment, each of the plurality of customers may be bank account holders of a particular bank. Further, the electronic device 102 may include a machine learning (ML) model 104. In order to manage financial wellbeing of each of the plurality of customers, initially, the electronic device 102 may be configured to receive a set of data instances associated with the plurality of customers from a plurality of data sources. In an embodiment, one or more of the set of data instances may be extracted form one or more of the plurality of data sources using any existing data extraction techniques. However, the set of data instances may be extracted from one or more of the financial institutions using open banking data aggregation. Moreover, the plurality of data sources may include, but is not limited to, Customer Relation Management (CRM) data source, financial institutions, third party data source, transaction data source, demographic information data source, product data source, social media data source, and contact center data source.

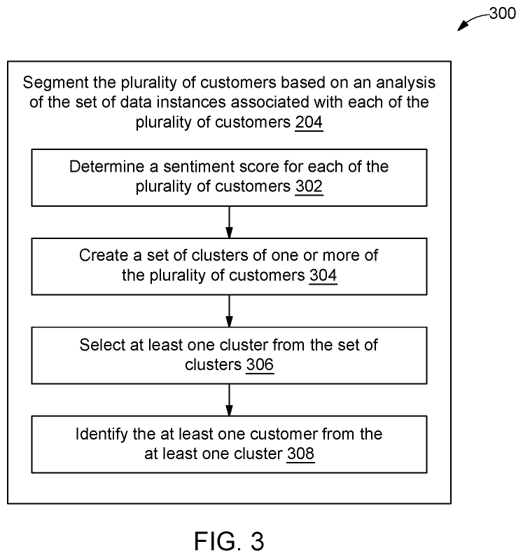

Once the set of data instances are received, the electronic device 102 may segment the plurality of customers. The segmentation of the plurality of customers may be performed based on an analysis of the set of data instances associated with each of the plurality of customers. A method of segmenting the plurality of customers has been explained in greater detail in conjunction with FIG. 3. Upon segmenting the plurality of customers, the electronic device 102 may identify at least one customer from the plurality of customers. Moreover, the at least one customer identified may have a value of at least one data instance from the associated set of data instances to be below an associated predefined threshold.

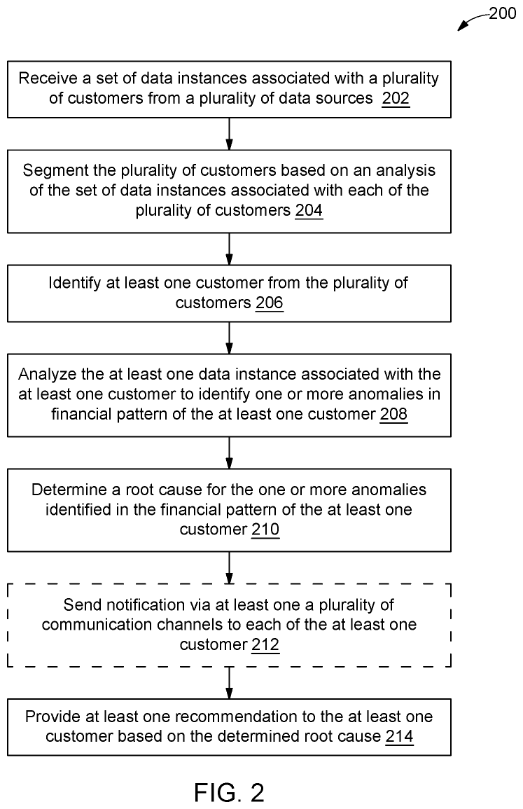

Further, the ML model 104 of the electronic device 102 may be configured to analyze the at least one data instance associated with the at least one customer. The at least one data instance may be analyzed to identify one or more anomalies in financial pattern of the at least one customer. Based on analysis, the ML model 104 may be configured to determine a root cause for the one or more anomalies identified in the financial pattern of the at least one customer. The root cause for the one or more anomalies may be determined based on analysis of each of the set of data instances. Once the root cause is determined, the electronic device 102 may provide at least one recommendation to the at least one customer based on the determined root cause. In an embodiment, the at least one recommendation may include one or more financial attributes. The complete process followed by the system 100 is further explained in detail in conjunction with FIG. 2 to FIG. 8.

Examples of the electronic device 102 may include, but are not limited to, a server, a desktop, a laptop, a notebook, a tablet, a smartphone, a mobile phone, an application server, or the like. The electronic device 102 may further include a memory 106, a processor 108, and a display 110. The display 110 may further include the user interface 112. The end-user may interact with the electronic device 102 and vice versa through the display 110.

By way of an example, the display 110 may be used to display results (i.e., the set of data instances associated with the plurality of customers, the at least one customer with the value below than the threshold, the financial pattern of the at least one customer, the one or more anomalies in the financial pattern, the root cause associated with the one or more anomalies, etc.,) based on actions performed by the electronic device 102, to an end-user (i.e., bank agent or bank executive). Moreover, the display 110 may be used to display the at least one recommendation provided to the at least one customer based on the root cause identified for each of the one or more anomalies. The at least one recommendation may change based on analysis of the set of data instances associated with a new customer.

By way of another example, the user interface 112 may be used by the at least one customer to provide inputs to the electronic device 102. Thus, for example, in some embodiment, the end user may ingest an input via the electronic device 102 that includes a user selection for notification received in response to the one or more anomalies identified. Further, for example, in some embodiments, the electronic device 102 may render intermediate results (e.g., the set of data instances associated with the plurality of customers, the at least one customer with the value below than the threshold, the financial pattern of the at least one customer, the one or more anomalies in the financial pattern, the root cause associated with the one or more anomalies, financial status of the at least one customer, information related to the anomalies) or final results (e.g., the at least one recommendation) to the end-user via the user interface 112.

The memory 106 may store instructions that, when executed by the processor 108, may cause the processor 108 to manage financial wellbeing of customers. As will be described in greater detail in conjunction with FIG. 2 to FIG. 8, in order to manage financial wellbeing of the plurality of customers, the processor 108 in conjunction with the memory 106 may perform various functions including segmentation of the plurality of customers, identification of the at least one customer, analysis of the at least one data instance, determination of the root cause for the one or more anomalies identified, providing the at least one recommendation, etc.

The memory 106 may also store various data (e.g., the set of data instances associated with each of the plurality of customers, the one or more anomalies, the associated root cause, the at least one recommendation, etc.) that may be captured, processed, and/or required by the electronic device 102. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random-Access Memory (DRAM), Static Random-Access memory (SRAM), etc.).

Further, the database 114 connected to the electronic device 102 may be used to store the set of data instances associated with the plurality of customers, the financial pattern of the at least one customer, the one or more anomalies in the financial pattern, the root cause associated with the one or more anomalies, financial status of the at least one customer, information related to the anomalies, etc. In addition, the database 114 may store net promoter's percentage (i.e., Net Promoters Score (NPS)) calculated based on satisfaction of each of the at least one customer. Additionally, the database 114 may be periodically updated based on the one or more anomalies and the associated root cause.

Further, the electronic device 102 may interact with a server 116 or external devices 122 over a network 120 for sending and receiving various data. The external devices 122 may be used by the plurality of customer to provide their selection for the notification received from the electronic device 102. In addition, the external devices 122 may be used by the plurality of customers to provide response for the at least one recommendation. Examples of the external devices 122 may include, but is not limited to, computer, tablet, mobile, and laptop. The network 120, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

In some embodiment, the electronic device 102 may fetch one or more of the set of data instances associated with the plurality of customers from the server 116. In addition, the server 116 may provide access of the information associated with each of the plurality of customers to AI virtual agents or bank agents. The server 116 may further include a database 118. The database 118 may store information associated with each of the plurality of customers. By way of an example, the database 118 may store the information associated with the plurality of customers in order to identify the one or more anomalies in the financial pattern of the at least one customer. The database 118 may be periodically updated with new information available for each of the plurality of customers.

Referring now to FIG. 2, a flowchart of a method 200 for managing financial wellbeing of customers is illustrated, in accordance with an embodiment. At step 202, a set of data instances associated with a plurality of customers may be received from a plurality of data sources. In an embodiment, one or more of the set of data instances may be extracted form one or more of the plurality of data sources using any existing data extraction techniques. Moreover, the set of data instance may be extracted from one or more of the financial institutions using open banking data aggregation. Further, the plurality of data sources may include, but is not limited to, CRM data source, financial institutions, third party data source, transaction data source, demographic information data source, product data source, social media data source, and contact center data source.

In an embodiment, the set of data instance may include financial data and personal data. By way of an example, the financial data associated with each of the plurality of customers may include customer financial status received from CRM data source, customer financial details received from third party data source or financial institutes, number of card transactions and transaction details received from transaction data sources, and alike. By way of another example, the personal data of each of the plurality of customers may be fetched from social media data source and contact center.

Once the set of data instances associated with the plurality of customers are received, at step 204, the plurality of customers may be segmented. The segmentation of the plurality of customers may be done based on an analysis of each of the set of data instances associated with each of the plurality of customers. In an embodiment, the analysis of each of the one or more of the set of data instances may be done based on information collected for the at least one customer for a predefined time period. By way of an example, analysis of the financial data of the at least one customer may be done based on information, such as, credited salary amount, financial status of the at least one customer, transaction data, household expenses, etc., collected for previous six months. In reference to FIG. 1, the analysis of the each of the one or more of the set of data instances may be done using the ML model 104. The method of segmentation of the plurality of customers is further explained in greater detail in conjunction with FIG. 3. Upon segmenting, at step 206, at least one customer may be identified from the plurality of customers with a value of at least one data instance from the associated set of data instances to be below an associated predefined threshold.

Once the at least one customer is identified, then at step 208, the at least one data instance associated with the at least one customer may be analyzed to identify one or more anomalies in financial pattern of the at least one customer. Examples of one or more anomalies may include, but is not limited to, negative balance, near payment due date, recurring card fees, mortgage burden, and household expenses. It should be noted that, the one or more anomalies may change as per each of the plurality of customers. In an embodiment, the at least one customer with the one or more anomalies in the financial pattern may be considered to be financially stressed (i.e., financial crises). In reference to FIG. 1, the ML model 104 may be trained to identify anomalies in the financial pattern of customers based on a first training data set and to determine root causes for anomalies based on a second training data set.

The first training data set may include a plurality of anomalies associated with the financial data and the personal data. Additionally, the second set of data set may be a set of root cause associated with each of the plurality of anomalies. In an embodiment, the trained ML model 104 may correspond to a predictive model that will identify whether there is any anomaly present in financial pattern (also referred as financial behavior) of a particular customer within last six months. Moreover, the ML model 104 may be trained to identify the one or more anomalies using a supervised learning algorithm (for example: K-Nearest Neighbor).

Upon identifying the one or more anomalies in the financial pattern of the at least one customer, at step 210, a root cause associated with each of the one or more anomalies identified in the financial pattern of the at least one customer. In an embodiment, the one or more anomalies may be identified based on analysis of each of the set of data instances. By way of an example, the root cause associated with the one or more anomalies may include, but is not limited to, lost job, sudden medical emergency, bankruptcy, mortgage installments, and household expenses.

Once the root cause is identified, at step 212, a notification may be sent to each of the at least one customer having the one or more anomalies in their financial patterns. In an embodiment, the notification may be sent via a plurality of communication channel. Examples of the plurality of communication channel may include, but is not limited to, mobile banking application, internet banking, bank branch, telephone, automated teller machine (ATM), and an admin portal. Further, the notification may include, at least one of a customer personal financial status, information related to at least one anomaly identified in the financial pattern of the at least one customer, and a link to initiate communication related to the at least one anomaly by the at least one customer, with an agent. In an embodiment, the link may be shared with the at least one customer to initiate visual communication (e.g., by a video call) with the agent. Moreover, the agent may be the AI virtual agent or the bank agent.

Further, at step 214, at least one recommendation may be provided to the at least one customer based on the determined root cause. The at least one recommendation may include one or more financial attributes. Further, the one or more financial attributes may include information related to increasing saving, reducing debt burden, and cross sell or up sell of relevant product. By way of an example, once the link is shared with the at least one customer and the at least one customer is visually connected with the agent, then, the agent may be able to provide the at least one recommendation to each of the at least one customer with empathy, based on the one or more anomalies identified in the associated financial pattern. Moreover, the at least one recommendation provided to each of the at least one customer may be hyper-personalized as per each of the at least one customer, based on the one or more anomalies identified in the associated financial pattern.

Referring now to FIG. 3, a flowchart of a method 300 for segmenting a plurality of customers is illustrated, in accordance with an embodiment. In reference to FIG. 2, as mentioned at step 202, in order to segment the plurality of customers, at step 302, a sentiment score for each of the plurality of customers may be determined based on analysis of a subset of associated data instances. In an embodiment, the subset of associated data instances may correspond to a subset of financial data instances and a subset of personal data instances. In an embodiment, the sentiment score may be calculated based on a predefined threshold associated with each of the subset of data instances.

Each of the subset of financial data instances may be fetched from CRM data source, financial institutions, third party data source, transaction data source, demographic information data source, product data source. Moreover, each of the subset of personal data instances may be fetched from social media data source and contact center data source. In an embodiment, the analysis of each of the subset of financial data instances may be done to identify at least one of the plurality of customers with one or more issues in their financial behavior. Further, the analysis of each of the subset of personal data instances may be done to identify current sentiments of each of the plurality of customers.

Once the sentiment score associated with each of the plurality of customers is identified, at step 304, a set of clusters of one or more of the plurality of customers may be created. The set of clusters of one or more of the plurality of customers may be created based on similarity in the sentiment scores provided to each of the plurality of customers. By way of an example, one or more customers from the plurality of customers with the sentiment score ranging from ‘1’ to ‘5’ may be grouped together to create a cluster.

Further, at step 306, at least one cluster may be selected from the set of clusters. In an embodiment, each of the at least one cluster selected may have a value of the sentiment score above a predefined threshold score. In other words, each of the at least one cluster selected may have higher probability of having customers with the one or more issues in their financial behavior. Once the at least one cluster is selected, then at step 308, the at least one customer may be identified from the at least one cluster. In an embodiment, each of the at least one customer identified may be identified to have one or more anomalies in financial pattern.

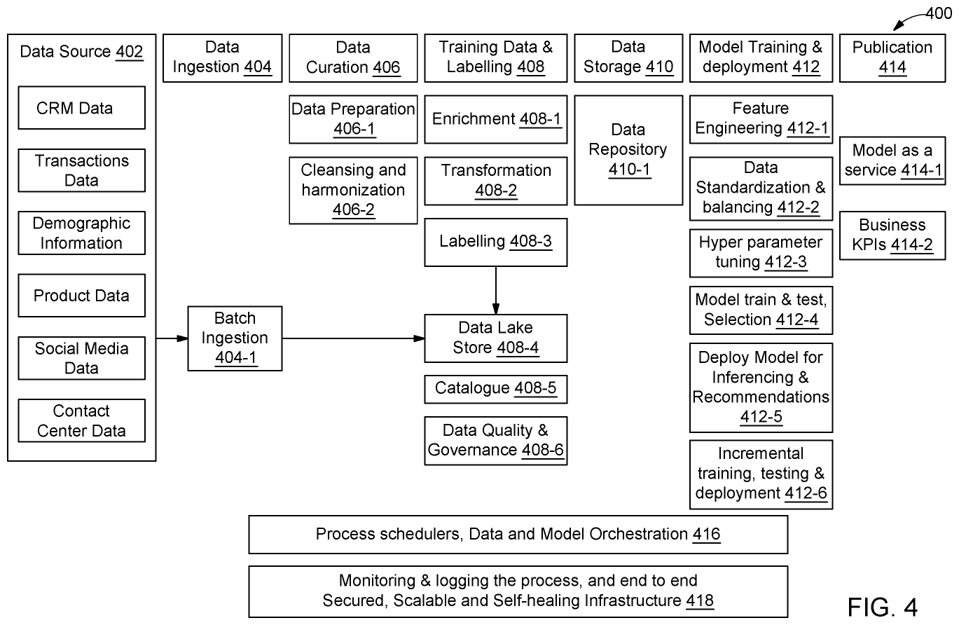

Referring now to FIG. 4, a logical architecture framework 400 for configuring a system to manage financial wellbeing of customers, is represented, in accordance with an embodiment. In reference to FIG. 1, the system may correspond to the system 100. Initially, information (i.e., the set of data instances) associated with the plurality of customers may be fetched from the plurality of data sources. As will be appreciated, the plurality of customers may be individual holding an account in a bank. In present FIG. 4, the plurality of data source may correspond to data sources 402. As depicted in the present FIG. 4, the data sources 402 may include, but is not limited to, CRM data source, transaction data source, demographic information data source, product data source, social media data source, and contact center data source. In addition to the depicted data sources 402, the plurality of data sources may also include financial institutes and third-party data source.

Once the information associated with the plurality of customers are fetched, then, at 404, data ingestion may be performed. It should be noted that, the data ingestion may be a process in which data (i.e., the information) fetched from various data sources (i.e., the data sources 402) may be moved and stored in a data lake store 408-4 for further analysis. In an embodiment, the fetched information may be stored in the data lake store 408-4 during data ingestion using batch ingestion technique 404-1. It should be noted that, the batch injection technique 404-1 may be used to store the information fetched in form of tables. In an embodiment, during storing of the information fetched for the plurality of customers, a catalogue 408-5 may be created. Further, once the catalogue 408-5 is created, at 408-6, quality and governance test may be performed in order to determine accuracy of the fetched information.

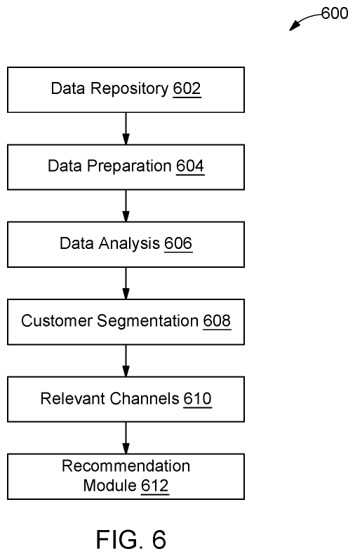

Once the data ingestion 404 is performed, at 406, curation of data may be done. The curation of data may include data preparation 406-1 and cleaning and harmonization of data 406-2. This has been-explained in greater detail in conjunction to FIG. 6. Further, at 408, training data may be prepared by generating labels to the fetched information. By way of an example, the information fetched from the data sources 402 may be raw information. This raw information fetched may be labeled by adding tags. In an embodiment, the preparation of the training data may include data enrichment 408-1, data transformation 408-2, and data labeling 408-3.

As already known in art, the data enrichment 408-1 may correspond to a technique for appending or enhancing data, based on relevant data obtained from addition data sources. In an embodiment, the data may correspond to the information fetched from the data sources 402. Moreover, the data transformation 408-2 may correspond to a technique of converting data from one form to another, i.e., from a source format to a required format. Further, the data labeling 408-3 may correspond to a technique for adding meaningful and informative labels in order to add context to the raw information, which is understandable by an ML model. In reference to FIG. 1, the ML model may correspond to the ML model 104.

Once the raw information is labeled, then the labeled raw information may be sent for storage to the data lake store 408-4. In addition, at 410, the labeled raw information may be stored separately in a data repository 410-1. Further, at 412, training and deployment of the ML model may be done based on the labeled dataset. In order to training the ML model, initially, at 412-1, feature engineering may be performed on the labeled raw information to generate a labeled dataset. It should be noted that, feature engineering is a well-known technique that is used for extracting features that can be used for performing supervised learning for the ML model using the labeled dataset.

Further, at 412-2, data standardization and balancing may be performed on the labeled dataset. Once the standardization and the balancing of the labeled dataset is done, at 412-3, hyperparameter tuning may be performed on the labeled dataset. It should be noted that, hyperparameter tuning is a technique that is used for selecting a set of appropriate hyperparameters for each of a learning algorithm used for training the ML mode. Further, at 412-4, training and testing of the ML model may be done based on each of the set of optimal hyperparameters and the associated learning algorithm. Further, based on training and testing performed for the ML model, the ML model with highest accuracy may be selected for deployment.

Once the ML model is selected, then at 412-5, the selected ML model may be deployed for inferencing and for providing appropriate recommendation. In an embodiment, the appropriate recommendation may correspond to the at least one recommendation. Further, at 412-6, incremental testing, training, and deployment may be performed for the ML model based on a new information received from the data sources 402. In an embodiment, the incremental learning for the ML model may be performed based on a reinforcement learning technique. Once the ML model is tested, trained, and deployed, at 414, publication of the ML model may be done. In an embodiment, the publication of the ML model may include publication of the ML model as a service 414-1 and publication of business KPIs 414-2 of the ML model. In other words, the publication of the ML model may be referred as providing the developed ML model for usage to the end-users (for e.g., banks).

In addition, at 416, process scheduling and model orchestration may be performed. It should be noted that, the process scheduling for the ML models may be done for efficient handling of process running via the ML model. In addition, the model orchestration may be performed to automate configuration, management, and coordination, computer system on which the ML model is deployed along with applications and services running on the computer system. In reference to FIG. 1, the computer system may correspond to the electronic device 102. Further, at 418, each of the deployed ML model may be monitored and logged to track any issues in the ML model that may affect its functioning. Moreover, monitoring and logging of the ML model may be done so that an end-to end secure, scalable, and self-healing infrastructure may be provided to the end-users. The end-to-end secure, scalable, and self-healing infrastructure provided to the end-users may enable the end-users to remediate any operational challenges of the ML model, faced by the end-users, in a cost-effective way.

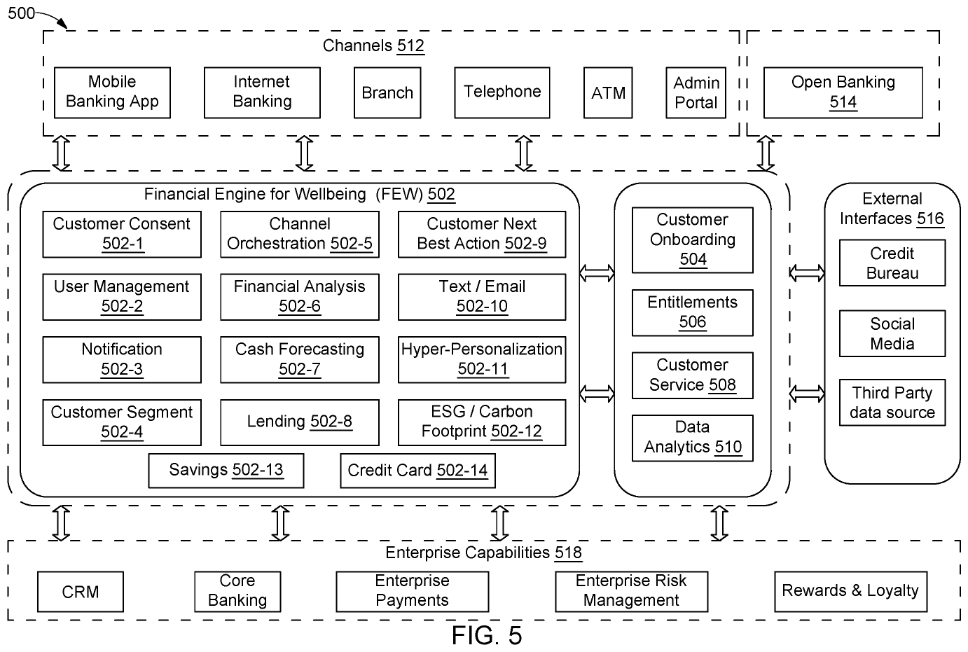

Referring now to FIG. 5, a functional architecture framework 500 for managing financial wellbeing of customers is represented, in accordance with an embodiment. In the functional architecture framework 500, a financial engine for wellbeing 502 is depicted. In reference to FIG. 1, the financial engine for wellbeing 502 may correspond to an application installed on the electronic device 102 of a bank that is configured to manage financial wellbeing of each of the plurality of customers of the bank. As depicted, the financial engine for wellbeing 502 may include a customer consent module 502-1, a user management module 502-2, a notification module 502-3, a customer segment module 502-4, a channel orchestration module 502-5, a financial analysis module 502-6, a cash forecasting module 502-7, a lending module 502-8, a customer next best action module 502-9, a text/email module 502-10, a hyper-personalization module 502-11, an Environmental Social and Governance (ESG)/carbon footprint module 502-12, a saving/deposit module 502-13, and a credit card module 502-14.

In an embodiment, the customer consent module 502-1 may be configured to receive customer consent form each of the plurality of customers to access their information (i.e., the set of data instances), initially, during onboarding of each of the plurality of customers. In addition, the customer consent module 502-1 may be configured to receive consent from the at least one customer before starting video conversation, by sending the notification to each of the at least one customer.

The user management module 502-2 may be configured to manage information received from each of the plurality of customers. The notification module 502-3 may be configured to send the notification to the at least one customer based on the one or more anomalies identified in the financial pattern and the associated root cause. In an embodiment, the notification may be sent to each of the at least one customer via the plurality of communication channel. Further, the customer segment module 502-4 may be configured to segment each of the plurality of customers based on an analysis of the set of data instances associated with each of the plurality of customers.

The channel orchestration module 502-5 may be configured identify one or more appropriate communication channel from the plurality of communication channels in order to initiate communication with each of the at least one customer to efficiently engage each of the at least one customer. Further, the financial analysis module 502-6 may be configured to monitor financial behavior of each of the at least one customer. The cash forecasting module 502-7 may be configured to perform cash forecasting for each of the at least one customer. The cash forecasting may be performed in order to predict future income, expenses, liability, and savings of each of the at least one customer.

The lending module 502-8 may be configured to provide lending, e.g., any kind of loan, to each of the at least one customer based on his financial needs and financial stability. The customer next best action module 502-9 may be configured to identify the at least one recommendation that can be provided to each of the at least one customer. Further, the text/email module 502-10 may be configured to generate a text or an email that needs to be shared with each of the at least one customer as the notification. The notification may include at least one of a customer personal financial status, information related to at least one anomaly identified in the financial pattern of the at least one customer, and the link to initiate communication related to the at least one anomaly by the at least one customer, with the agent.

The hyper-personalization module 502-11 may be configured to generate a hyper-personalized dashboard for each of the at least one customer. The hyper-personalized dashboard may help each of the at least one customer to get a clear insight of their financial behavior. The ESG/carbon footprint module 502-12 may be configured to identify and rate any potential investment made by each of the at least one customer. Upon identifying any potential investment, the ESG/carbon footprint module 502-12 may be configured to identify whether an ESG loan may be provided to one or more of the at least one customer based on his potential investment. The saving/deposit module 502-13 may be configured to analyze savings and deposits made by each of the at least one customer. Based on analyzing, a suitable recommendation may be provided to each of the at least one customer to increase their savings and to use their deposits efficiently. Further, the credit card module 502-14 may be configured to identify whether a credit card can be offer to one or more of the at least one customer to make him financially stable.

Additionally, the financial engine for wellbeing 502 may consider new customers onboarding 504 in the bank. The financial engine for wellbeing 502 may also consider entitlements 506 associated with the new customers onboarding 504. In addition to entitlements 506, customer services 508, i.e., services offered to the new customers may also be considered. In addition, data analytics module 510 may be configured to analyze information associated with the new customers in order to manage financial wellbeing of each of the new customers using the financial engine for wellbeing 502.

Further, the functional architecture framework 500 may depict the plurality of communication channels 512 via which the electronic device 102 may enable interaction with each of the plurality of customers. As depicted, the plurality of communication channels 512 may include, but is not limited to, mobile banking application, internet banking, branch banking, telephone, ATM, and admin portal. Further, the financial engine for wellbeing 502 may fetch information associated with each of the plurality of customers form the one or more financial institutes using open banking data aggregation depicted as an open banking 514.

Further, the financial engine for wellbeing 502 may interact via external interface 516 with other data sources in order to fetch additional information associated with each of the plurality of customers. As depicted in present FIG. 5, the other data sources may include, but is not limited to, credit bureau, social media data source, third party data source. Moreover, in order to manage financial wellbeing of each of the plurality of customers, the financial engine for wellbeing 502 may consider enterprise capabilities 518. As depicted in present FIG. 5, the enterprise capabilities 518 may include, but is not limited to, CRM, core banking, enterprise payments, enterprise risk management, and rewards and loyalty.

Referring now to FIG. 6, a detailed flowchart of a method 600 for managing financial wellbeing of customers is illustrated, in accordance with an embodiment. At 602, a data repository is depicted. The data repository may contain information (i.e., the set of data instances) associated with each of the plurality of customers that is fetched from the plurality of data sources. The plurality of data sources may include, but is not limited to, CRM data source, financial institutions, third party data source, transaction data source, demographic information data source, product data source, social media data source, and contact center data source.

By way of an example, the CRM data source may include information such as, ‘name’, ‘age’, ‘address’, ‘contact information’, and ‘contact preferences’ of each of the plurality of data sources. Further, the transaction data source may include information such as, ‘date of transactions’, ‘customer code’, ‘product code’, and ‘transaction amount’ of each of the plurality of customers. Further, the product data source may include information such as, ‘product code’, ‘product description’, ‘saving card or credit card’, and ‘loan and deposit’, associated with each of the plurality of customers. Moreover, the contact center data source may include information such as, ‘timestamp’, ‘voice recording’, ‘text or email’, and ‘chat history’, of each of the plurality of the plurality of customers.

Once the set of data instances associated with each of the plurality of customers are received, at step 604, data preparation may happen. In other words, each of the set of data instances received may be harmonized in order to improve quality of each of the set of data instances. In addition, the end-user (i.e., the AI virtual agent, the bank agent or bank executive) may be provided with a comparable view of each of the set of data instances received from the plurality of data sources. In order to harmonize each of the set of data instances, techniques such as data collation, data conversion, and data integration may be performed. Once done, then each of the set of data instances may be cleaned and enriched to remove inaccurate data and add additional information in order to provide harmonized view of each of the set of data instances.

Further, at step 606, data analysis may be performed on each of the set of data instances. In an embodiment, the data analysis may be performed in order to summarize and visualize each of the set of data instances. The summarization and visualization of each of the set of data instances associated with each of the plurality of customers may include Key Performance Indicators (KPIs) benchmarking, income, and expenditure trends, repeated financial behavior, and identification of data patterns.

Once the summarization and visualization of each of the set of data instances associated with each of the customers is done, at step 608, each of the plurality of customers may be segmented based on the analysis of each of the set of data instance. In order to segment each of the plurality of customers, the sentiment score may be determined for each of the plurality of customers based on the subset of associated data instances. Once the sentiment score is determined, one or more of the plurality of customers may be grouped to create the set of clusters based on similarity in the associated sentiment score. In other words, the one or more of the plurality of customers may be grouped based on metrices, such as, cagey, ‘product categories’, ‘income’, financial status, etc. In an embodiment, in order to form the set of clusters, techniques such as hierarchical clustering, k-means clustering, and KNN. Once the set of clusters are formed, the at least one customer from the plurality of customers having the one or more anomalies in the financial pattern may be identified.

Upon identification of the at least one customer, at step 610, a relevant channel from the plurality of communication channels may be identified for initiating communication with each of the at least one customer. Examples of relevant channels may include, but is not limited to, mobile banking application, internet banking, branch banking, telephone, ATM, and admin portal. In an embodiment, the relevant channel may be identified based on efficiency of channel responsible for maximizing conversation, response rate, and effectiveness. Moreover, the relevant channel may be identified using techniques such as, logistic regression, decision tree, random forest, XGBoost, CatBoost, LightGBM, and ensemble model.

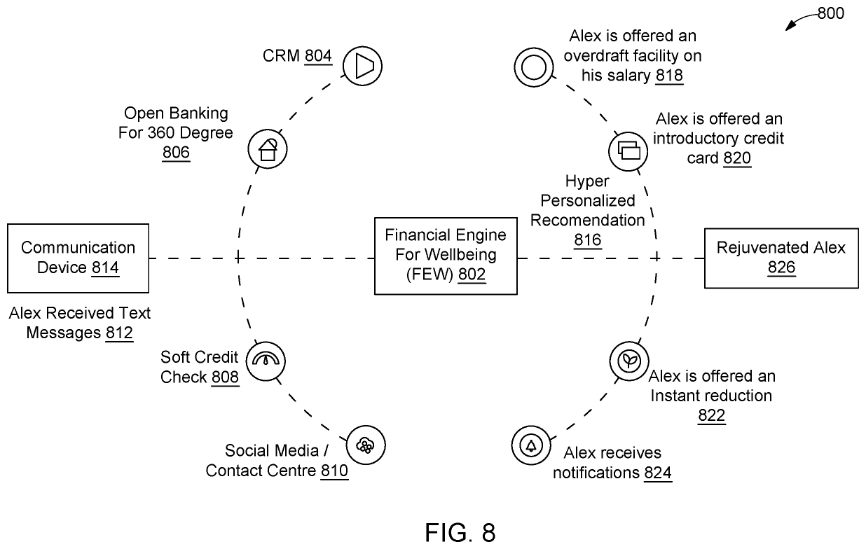

Once the relevant channel for communication is identified, then the link may be sent to the at least one customer to initiate communication related to the one or more anomalies, with the AI virtual agent or the bank agent. This process has been further explained in detail in conjunction to FIG. 8. Upon sharing the link, when connection is setup via the relevant channel, then at step 612, a recommendation module may be configured to provide at least one recommendation to the at least one customer, based on the root cause of the one or more anomalies in the financial pattern of the at least one customer. The at least one recommendation may include one or more financial attributes. Further, the one or more financial attribute may include, but is not limited to, information related to increasing saving, reducing debt burden, and cross sell or up sell of relevant product. In an embodiment, the at least one recommendation provided to the at least one customer may be determined using techniques, such as, collaborative filtering, content-based filtering, hybrid recommendation, logistic regression, decision tree, random forest, deep neural network, XGBoost, and CatBoost.

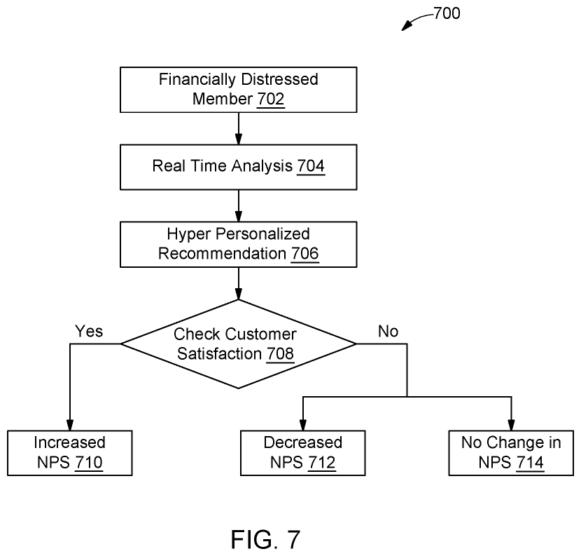

Referring now to FIG. 7, a flowchart of a method 700 for determining net promoters score is illustrated, in accordance with an embodiment. At step 702, a financially distressed member may be identified. In reference to FIG. 2, the financially distressed member may correspond to the at least one customer from the plurality of customers. The at least one customer selected may have the value of the at least one data instance from the associated set of data instances to be below the associated predefined threshold. Once the financially distressed member is identified, at step 704, each of the at least one data instance may be analyzed in real-time in order to identify the at least one or more anomalies in the financial pattern of the at least one customer. Upon identifying the one or more anomalies, the root cause associated with the one or more anomalies may be determined. In an embodiment, the root cause of the one or more anomalies may be determined based on analysis of each of the set of data instances associated with the financially distressed member.

Upon determining the root cause, at step 706, a hyper-personalized recommendation may be provided to the financially distressed member via the relevant channel identified from the plurality of communication channels. In reference to FIG. 2, the hyper personalized recommendation may correspond to the at least one recommendation provided to each of the at least one customer. Based on the hyper personalized recommendation provided to the financially distressed member, at step 708, a check may be performed to determine whether the financially distressed member is satisfied based on the hyper personalized recommendation provided to him. In one embodiment, based on the check performed, when the financially distressed member is identified to be satisfied, then at step 710, net promoter score (NPS) may be increased. In this embodiment, the NPS may be increased, when the financially distress member may provide positive feedback for bank, upon satisfaction.

In another embodiment, based on the check performed, when the financially distressed member may not be satisfied based on the hyper personalized recommendation provided to him, then two scenarios may be possible. In first scenario, when the financially distressed member is not satisfied, then the financially distressed member may provide negative response for the bank. Based on the negative response provided, at step 712, there may be reduction in the NSP. In second scenario, when the financially distressed member is not satisfied, then the financially distressed member may provide no response. In case, if no response is provided by the customer, then at step 714, no change may be done in the NSP of the bank.

Referring now to FIG. 8, an exemplary process 800 for managing financial wellbeing of customers is illustrated, in accordance with some exemplary embodiment. Consider a scenario, where a bank may periodically receive each of the set of data instances associated with each of the plurality of customers of the bank, from the plurality of data sources. In reference to FIG. 1, the bank may be monitoring the set of data instances based on an application (i.e., a financial engine for wellbeing 802) installed on the electronic device 102. Based on monitoring, each of the plurality of customers may be segmented to identify at least one customer having the value of the at least one data instance, below the associated pre-defined threshold. The method to perform segmentation of each of the plurality of customers has been already explained in reference to the FIG. 3.

In this scenario, as depicted the at least one customer identified may be Alex. Moreover, the value of the at least one instance may be salary credit. In addition, the predefined threshold associated with the salary credit may be set for 2 times. Further, in this scenario, upon monitoring each of the set of data instances associated with Alex, an agent of the bank may identify that from past three months, salary of Alex has not been credited in his bank account. In other words, the salary credit instance may be determined to have the value below than the threshold.

The financial engine for wellbeing 802 wellbeing may analyze each of the set of data instances associated to Alex to identify one or more anomalies in financial pattern of Alex. Examples of one or more anomalies may include, but is not limited to, negative balance, near payment due date, recurring card fees, mortgage burden, and household expenses. By way of an example, the financial engine for wellbeing 802 may analyze a data instance received from a CRM data source 804 for monitoring complete bank internal view (i.e., 360-degree view) of Alex. Further, the financial engine for wellbeing 802 may analyze one or more data instances received from other financial institutes to obtain open banking 360-degree view 806, of Alex. In an embodiment, the one or more data instances from other financial institutes may be extracted using open banking data aggregation.

It should be noted that, the open banking data aggregation may be built based on Open Banking Implementation Entity (OBIE) framework. Moreover, the open banking data aggregation may be initiated with integrating endpoints exposed by banks participating in open banking ecosystem under competent authorities or regulatory guidelines. Additionally, in order to perform the open banking data aggregation, Application Programming Interface (APIs) exposed in bank's developer portal and dummy data may have leveraged to accelerate prototype of open banking development. Particularly, sandbox test facility and developer portal may have been used to build a real-life open banking data aggregation.

As will be appreciated, in order to obtain open banking 360-degree view, consent for customer (i.e., Alex) may be needed. Based on the customer consent, open banking read only API financial data may be fetched using the open banking data aggregation for benefit of customer in adherence to applicable regulations such as, Payment Services Directives (PSD2), CCPA, GDPR or any other consumer data protection laws. Moreover, a secured read access channel may be established through exposed endpoints of the bank's using open authorization framework, i.e., OAuth 2.0. In other words, the open banking data aggregation may be done based on the customer consent, customer authentication, and confirmation from customer, adhering to standards, such as, financial grade API integration, read only API security profile, and adherence to requirements of the OAuth 2.0.

In an embodiment, open banking data aggregation may accelerate analytics with enriched data alone with enhancement in accuracy of an ML model in aspects such as, cash forecasting (i.e., prediction of customer's future income, customer's expenses, customer's liability, and customer's savings), enriched 360-degree view of the customer financially, and by providing hyper-personalized experience to the customer. In reference to FIG. 1, the ML model may correspond to the ML model 104.

Further, the financial engine for wellbeing 802 may perform soft credit check 808 in order to review credit reports of Alex, without impacting credit score. Moreover, the financial engine for well being 802 may analyze one or more data instance fetched from the social media data source and the contact center data source 810, of Alex. In an embodiment, the one or more instances fetch from the social media data source and the contact center data source may be analyzed to perform sentiment analysis. Moreover, the sentiment analysis may be performed to identify stress level of Alex.

In an embodiment, the sentiment analysis may be performed by bank executive to drive meaningful conversation with Alex. In addition, the sentiment analysis may help to identify potential churn of Alex and to take right step for increasing NPS. As will be appreciated, data instances from the social media data source may be analyzed based on consent received from Alex, by using Natural Language Processing (NLP). In addition, data instances captured as part of historical conversation between Alex and bank support center from the contact center data source may be analyzed using contextual mining and text analysis. Moreover, in order to identify Alex stress level, endpoints from multiple social media platforms APIs and recent social media posts along with conversation may be analyzed, based on Alex consent.

In order to perform efficient sentiment analysis for obtaining better results, three-step sentiment analysis has been used. The three-step sentiment analysis may include rule-based approach, hybrid analysis approach, and a trained ML model. In reference to FIG. 1, the trained ML model may correspond to the ML model 104. In the rule-based approach, manually crafted rules may be utilized. The manually crafted rules may help the bank executive to identify dissatisfied customers and customers that will potentially churn. Moreover, in the rule-based approach, cases with customers visiting branch multiple times, raising complaints, calling customer support, have unresolved open tickets, and crossing a predefined threshold set through standard rules may be considered.

Further, in the hybrid analysis approach, a self learnt ML model (i.e., the ML model 104) may be used in combination with one or more financial attributes to identify current mood and sentiment of Alex. As will be appreciated, the self learnt ML model may be automatically retain itself upon identifying new financial attributes emerged based on new anomalies identified in financial pattern of a customer, in order to increase its efficiency. Moreover, the trained ML model may be used to perform efficient sentiment analysis as, the trained ML model may help to generate sentiment score, generate feature vector, and categorize sentiment polarity. In order to train the ML model, ML algorithms such as, logistic regression, decision tree, ensemble models, and deep learning may be used.

Moreover, the trained ML model may be configured to learn from customer past financial data to predict sentiment of the customer (i.e., Alex). Moreover, in order to predict the sentiments techniques such as, stemming, tokenization, sentiment sentence extraction, part-of-speech (POS) tagging, and parsing may be used. Particularly, the POS tagging technique may be very effective in performing the sentiment analysis by identifying verb that could effectively represent sentiment, as words like nouns and pronouns don't contain any sentiment.

Further, based on analysis of each of the set of data instances, upon identifying the one or more anomalies and the root associated with the one or more anomalies, the financial engine for wellbeing 802 may share a notification via one of the plurality communication channels, e.g., via text message 812, to Alex. The text message 812 may be sent to Alex on a communication device 814 used by him. In an embodiment, the notification may include, at least one of: a customer's (i.e., Alex) personal financial status, information related to the at least one anomaly identified in the financial pattern of Alex, and a link to initiate communication related to the at least one anomaly by Alex, with an agent. In an embodiment, the agent may be the AI virtual agent or the bank agent.

Upon receiving the notification, Alex may share his consent to initiate video conversation with the agent or schedule a video conversation sometime later, via the received link. Based on consent received from Alex, the financial engine for wellbeing 802 may provide the at least one recommendation to Alex, via a hyper-personalized dashboard. In present FIG. 8, the at least one recommendation may correspond to the hyper-personalized recommendation 816. As will be appreciated, the agent may enable video conversation to provide the at least one recommendation in order to have conversation Alex with empathy.

By way of an example, in this scenario, as depicted, the at least one recommendation provide to Alex may include an overdraft facility of his salary account 818. The overdraft facility provided to Alex on his salary account may help Alex by removing tension for paying penalty for having negative balance amount in his salary account. By way of another example, the at least one recommendation provided to the Alex may include offering of an introductory credit card 820, to Alex. The introductory credit card offered to Alex may have zero percent Annual Percentage Rate (APR) for 18 months, to help Alex to pay his monthly Equated Monthly Installment (EMI) for loan and other payment utilities. By way of yet another example, the at least one recommendation provide to Alex may include instant reduction 822, say in his mortgage interest rate for house, as his house has solar system implemented. By way of yet another example, the at least one recommendation provided to Alex may include some suggestion associated with his spendings 824. The suggestion on his spendings 824 may increase his awareness towards his spendings, thereby enabling him to better manage his spendings. Further, based on each of the at least one recommendation provided to Alex, Alex may feel rejuvenated 826 as he will have increased liquidity/cash, he will be able to better manage his spendings, he will be able to pay of his debts, and will have increased savings.

Moreover, the hyper-personalized dashboard is used to provide the at least one recommendation, as the hyper-personalized dashboard may help providing each customer (here Alex) with an insight of where the customer is going wrong in his financial behavior, and then educating the customer about those key attributes that may be impacting his financial status. In an embodiment, the key attributes considered may include, but is not limited to, average account balance, average monthly expenditure, average monthly income, fees, and charges applied every month, similar subscriptions, expense categories, credit Score, upcoming out-pay, and comparison with peer group. Moreover, each of the key attributes may b e personalized as per each customer.

The hyper personalized dashboard may further provide a drilled down insight with a graphical visualization of financial indicators that are just a hover away to each customer. In addition, a list of recommendations may be part of the hyper-personalized dashboard where further clarification can be sought with an interactive video chat built on Azure communications. Moreover, a direct integration may be provided with bank system APIs in order to enable live action based on each of the at least one recommendation. Moreover, with just a click, the customer may be able to take necessary action based on each of the at least one recommendation provided to him in order to bring that action to immediate effect, or a real-time request will be placed to core banking system or to respective business application to bring that action to effects.

Various embodiments provide method and system for managing financial wellbeing of customers. The disclosed method and system may receive a set of data instances associated with a plurality of customers from a plurality of data sources. Further, the disclosed method and system may segment the plurality of customers based on an analysis of the set of data instances associated with each of the plurality of customers. Moreover, the disclosed method and system may identify at least one customer from the plurality of customers. A value of at least one data instance from the set of data instances associated with the at least one customer is below an associated predefined threshold. Additionally, the disclosed method and system may analyze the at least one data instance associated with the at least one customer to identify one or more anomalies in financial pattern of the at least one customer. Further, the disclosed method and system may determine a root cause for the one or more anomalies identified in the financial pattern of the at least one customer, based on analysis of each of the set of data instances. In addition, the disclosed method and system may provide at least one recommendation to the at least one customer based on the determined root cause.

The method and system provide some advantages like, the method and system may provide certain benefits for financial institutes and banks, such as, increase in digital engagement through intelligent customer engagement solution with omni channel and remote capability, ability to navigate customers to their next best action, thereby increasing customer satisfaction (CSAT) by 90%, increase in savings of customers that may result in growth in deposit and credit portfolio for financial institutes and banks, helping financial institutes and banks to catalyze digital-led growth via cloud first approach, increase in predictability on Cloud OPEX and reduce volatility, and accelerate revenue growth and profitability for financial institutes and banks.

Further, in addition to providing benefits to financial institutes and banks, the method and system may also provide technical advantages, such as, the disclosed method and system may provide extremely scalable, secure, flexible, reliable, and portable solution on cloud. In addition, the method and system may provide higher degree of data security and encryption and is fully compliant with General Data Protection Regulation (GDPR), California Consumer Privacy Act (CCPA), Personal Data Protection Act (PDPA), lower time to market. Moreover, the disclosed method and system may provide a cloud vendor agnostic solution to the financial institutes and banks along with the customers.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for managing financial wellbeing of customers, the method comprising:
receiving, by an electronic device, a set of data instances associated with a plurality of customers from a plurality of data sources;
segmenting, by the electronic device, the plurality of customers based on an analysis of the set of data instances associated with each of the plurality of customers;
identifying, by the electronic device, at least one customer from the plurality of customers, wherein a value of at least one data instance from the set of data instances associated with the at least one customer is below an associated predefined threshold;
analyzing, by the electronic device via a Machine Learning (ML) model, the at least one data instance associated with the at least one customer to identify one or more anomalies in financial pattern of the at least one customer;
determining, by the electronic device via the ML model, a root cause for the one or more anomalies identified in the financial pattern of the at least one customer, based on analysis of each of the set of data instances; and
providing, by the electronic device, at least one recommendation to the at least one customer based on the determined root cause.

2. The method as claimed in claim 1, wherein the plurality of data sources comprises Customer Relation Management (CRM) data source, financial institutions, third party data source, transaction data source, demographic information data source, product data source, social media data source, and contact centre data source.

3. The method of claim 1, wherein the set of data instances is extracted from one or more of financial institutions using open banking data aggregation.

4. The method of claim 1, wherein segmenting the plurality of customers comprises:
determining a sentiment score for each of the plurality of customers based on analysis of a subset of associated data instances, wherein the sentiment score is provided based on a predefined threshold associated with each of the subset of data instances; and
creating, via the ML model, a set of clusters of one or more of the plurality of customers, based on similarity in the sentiment scores provided to each of the plurality of customers.

5. The method of claim 4, further comprising:
selecting at least one cluster from the set of clusters, wherein the sentiment score for each of the at least one cluster is above a predefined threshold score; and
identifying the at least one customer from the at least one cluster.

6. The method of claim 1, wherein analysis of each of the one or more of the set of data instances is done based on information collected for the at least one customer for a predefined time period via the ML model.

7. The method of claim 1, wherein the ML model is trained to identify anomalies in financial pattern of customers based on a first training data set and to determine root causes for anomalies based on a second training data set.

8. The method of claim 1, wherein the at least one recommendation comprises one or more financial attributes, and wherein the one or more financial attributes comprises information related to increasing saving, reducing debt burden, and cross sell or up sell of relevant product.

9. The method of claim 1, further comprising:
sending notification via at least one a plurality of communication channels to each of the at least one customer, wherein the notification comprises:
at least one of a customer personal financial status;
information related to at least one anomaly identified in the financial pattern of the at least one customer; and
a link to initiate communication related to the at least one anomaly by the at least one customer, with an agent.

10. The method of claim 9, wherein the agent is an Artificial Intelligence (AI) virtual agent or a bank agent.

11. A system for managing financial wellbeing of customers, the system comprising:
a processor; and
a memory communicatively coupled to the processor, wherein the memory stores processor executable instructions, which, on execution, causes the processor to:
receive a set of data instances associated with a plurality of customers from a plurality of data sources;
segment the plurality of customers based on an analysis of the set of data instances associated with each of the plurality of customers;
identify at least one customer from the plurality of customers, wherein a value of at least one data instance from the set of data instances associated with the at least one customer is below an associated predefined threshold;
analyze the at least one data instance associated with the at least one customer to identify one or more anomalies in financial pattern of the at least one customer;
determine, via a Machine Learning (ML) model, a root cause for the one or more anomalies identified in the financial pattern of the at least one customer, based on analysis of each of the set of data instances; and
provide at least one recommendation to the at least one customer based on the determined root cause.

12. The system of claim 11, wherein the plurality of data sources comprises Customer Relation Management (CRM) data source, financial institutions, third party data source, transaction data source, demographic information data source, product data source, social media data source, and contact centre data source.

13. The system of claim 11, wherein the set of data instances is extracted from one or more of financial institutions using open banking data aggregation.

14. The system of claim 11, wherein to segment the plurality of customers, the processor executable instructions further cause the processor to:
determine a sentiment score for each of the plurality of customers based on analysis of a subset of associated data instances, wherein the sentiment score is provided based on a predefined threshold associated with each of the subset of data instances; and
create, via the ML model, a set of clusters of one or more of the plurality of customers, based on similarity in the sentiment scores provided to each of the plurality of customers.

15. The system of claim 14, wherein the processor executable instructions further cause the processor to:
select at least one cluster from the set of clusters, wherein the sentiment score for each of the at least one cluster is above a predefined threshold score; and
identify the at least one customer from the at least one cluster.

16. The system of claim 11, wherein analysis of each of the one or more of the set of data instances is done based on information collected for the at least one customer for a predefined time period via the ML model.

17. The system of claim 11, wherein the ML model is trained to identify anomalies in financial pattern of customers based on a first training data set and to determine root causes for anomalies based on a second training data set.

18. The system of claim 11, wherein the at least one recommendation comprises one or more financial attributes, and wherein the one or more financial attributes comprises information related to increasing saving, reducing debt burden, and cross sell or up sell of relevant product.

19. The system of claim 11, wherein the processor executable instructions further cause the processor to:
send notification via at least one a plurality of communication channels to each of the at least one customer, wherein the notification comprises:
at least one of a customer personal financial status;
information related to at least one anomaly identified in the financial pattern of the at least one customer; and
a link to initiate communication related to the at least one anomaly by the at least one customer, with an agent, wherein the agent is an Artificial Intelligence (AI) virtual agent or a bank agent.

20. A non-transitory computer-readable medium storing computer-executable instructions for managing financial wellbeing of customers, the stored instructions, when executed by a processor, cause the processor to perform operations comprises:
receiving a set of data instances associated with a plurality of customers from a plurality of data sources;
segmenting the plurality of customers based on an analysis of the set of data instances associated with each of the plurality of customers;
identifying at least one customer from the plurality of customers, wherein a value of at least one data instance from the set of data instances associated with the at least one customer is below an associated predefined threshold;
analyzing the at least one data instance associated with the at least one customer to identify one or more anomalies in financial pattern of the at least one customer;
determining a root cause for the one or more anomalies identified in the financial pattern of the at least one customer, based on analysis of each of the set of data instances; and
providing at least one recommendation to the at least one customer based on the determined root cause.
